(19) United States
(12) Patent Application Publication
(10) Pub. No.: US 2012/0208059 A1
(43) Pub. Date: Aug. 16, 2012

(54) METHOD FOR PRODUCING AN ENERGY STORAGE DEVICE FOR A VEHICLE

(76) Inventors: Markus KOHLBERGER, Stuttgart (DE); Michael MOSER, Rainau (DE); Hans-Georg HERRMANN, Stuttgart (DE)

(21) Appl. No.: 13/371,930

(22) Filed: Feb. 13, 2012

Related U.S. Application Data
(63) Continuation of application No. PCT/EP2010/061353, filed on Aug. 4, 2010.

(30) Foreign Application Priority Data
Aug. 13, 2009 (DE) 10 2009 037 063.3

(51) Int. Cl. H01M 2/10; H01M 10/04

(52) U.S. Cl. 429/100; 29/623.4

(57) ABSTRACT

A method for producing an energy storage device for at least one electrochemical energy storage unit is provided. The method includes a step of providing the at least one electrochemical energy storage unit suitable for providing energy for a drive of a vehicle, and a step of at least partially insert molding the at least one electrochemical energy storage unit in a casting compound in order to produce the energy storage device, wherein the at least one electrochemical energy storage unit is positively or adhesively connected to the casting compound in the insert molding step.

This nonprovisional application is a continuation of International Application No. PCT/EP2010/061353, which was filed on Aug. 4, 2010, and which claims priority to German Patent Application No. DE 10 2009 037 063.3, which was filed in Germany on Aug. 13, 2009, and which are both herein incorporated by reference.

### BACKGROUND OF THE INVENTION

1. Field of the Invention

The present invention relates to a method for producing an energy storage device with an electrochemical energy storage unit, which is suitable for powering a vehicle, and a corresponding device.

2. Description of the Background Art

In the case of batteries for hybrid and electric vehicles, a large number of galvanic cells are connected in series to achieve a higher voltage. In cell or battery modules of this type, the cells must be fixed, without there being a risk of damage, e.g., caused by vibrations which arise when the vehicle is driven.

EP 2 026 387 A1 relates to an electrochemical energy storage unit, which has a plurality of flat cells and a frame. The frame is connected to a flat cell to form a structural unit, for example, by gluing or welding.

Plastic compositions have already been arranged around individual cell packs for cell phones for a long time. In this case, simple fixing aids are also formed and the electronic protection circuits are enclosed. For example, so-called hot melts are used here.

The fact must be pointed out in this regard, however, that the structure of the cell phone battery pack is completely unsuitable for use in the automotive sector, because there the cells must provide much more energy; thereby, as is known, they are also larger and heavier, cooling is necessary, and the forces arising during operation are greater. The energy storage units in the mobile communication sector are therefore not designed for use in the automotive sector.

### SUMMARY OF THE INVENTION

It is therefore the object of the present invention to create an improved device for holding energy storage units for the automotive sector and an improved method for producing an energy storage device of said type.

The present invention is based on the realization that a form-fitting fixation and mechanical support of the (energy storage) cells (i.e., the energy storage units) in the cell or battery module can be achieved by forming a frame for retaining the battery module completely or partially by a directly molded part. In this case, a cell connecting rail for connecting a plurality of individual storage cells can already be fixed on the cell. This is possible with both hard case and coffee bag cells.

The form-fitting insert molding and/or insert molding with bonding can support the cell uniformly in all directions. The casting compounds, employed by way of example, with a polyamide base connect very stably to the surface of the cell, which in the case of a coffee bag cell typically includes a polyamide layer. Good adhesion of the polyamide to metals, or other coatings can also be achieved. The sheathing enables the dampening of vibrations during vehicle operation, is electrically insulating, and can protect the cell from possible corrosion.

In addition, in the case of cell cooling by means of cooling plates, said cooling plates can be insert molded in a very simple way. For this purpose, the cell can be connected to the cooling plate by means of pressure or a preceding adhesion. Together with the cooling plate, the cell can now be enclosed with the casting compound in an injection mold. During the subsequent attachment of a frame, considerably more complicated work steps would be needed which would require a precise insertion and fixation of the cooling plates.

The present invention creates in an embodiment a method for producing an energy storage device for at least one electrochemical energy storage unit, whereby the method comprises the following steps: preparation of the at least one electrochemical energy storage unit, which is suitable for providing energy for a drive mechanism of a vehicle, and at least partial insert molding of the at least one electrochemical energy storage unit with a casting compound to produce the energy storage device, whereby in the insert molding step the at least one electrochemical energy storage unit is connected form-fittingly and/or by bonding to the casting compound.

The electrochemical energy storage unit may be a battery or an accumulator, which is used for powering a hybrid or electric vehicle. To be able to provide in a suitable way the large number of energy storage units necessary for providing power, these units are preferably used as flat cells. Flat cells can be equipped with a rigid housing or, as so-called coffee bag cells, be packed in a film, so that they are lastingly deformable. The energy storage device can be used to support one or a plurality of electrochemical energy storage units and to hold them in an appropriate position. The energy storage device can be made, for example, as a type of sheathing, which can be formed to receive one or a plurality of electrochemical energy storage units.

The insert molding can be carried out in an injection molding process, in which, for example, a heated liquid casting compound is applied to the edge surfaces of an electrochemical energy storage unit, and then cools and solidifies. The casting compound can also be applied only to parts of the edge surfaces, for example, at the corners of the electrochemical energy storage unit. The casting compound used in the insert molding process can be a polyamide or some other thermoplastic polymer, which is characterized by high strength and good chemical resistance and processability. The use of a casting compound as sheathing for the at least one electrochemical energy storage unit offers many advantages. Thus, excellent protection from penetration of moisture, dust, foreign materials, water, etc., between the casting compound and the electrochemical energy storage unit(s) can be achieved by the precise binding of the casting compound to the electrochemical energy storage unit. Likewise, better electrical insulation of the cell can be realized with the use of a casting compound than could be made possible by the use, e.g., of a prefabricated rigid frame. In addition, the sheathing made of a casting compound can have a higher vibration and shock resistance than a conventional battery or accumulator frame, which is of great importance especially for use in the automotive sector.

The method of insert molding with a casting compound proves to be very advantageous during use of coffee bag cells as the electrochemical energy storage units. Because coffee bag cells are formed as lastingly deformable, insert molding is an optimal solution to hold the cells firmly in the appropriate position, because the casting compound can adhere well to a film surface of the cells. With the use of a prefabricated rigid frame, there is a greater risk of a sliding out of the cell(s), e.g., as a result of jarring.

The form-fitting and/or bonding connection between the electrochemical energy storage unit and the casting compound can be provided in that after the curing of the casting compound it completely or partially encloses the edge region of the electrochemical energy storage unit.

According to an embodiment, a mechanical support or retaining component for the at least one electrochemical energy storage unit can be formed in the insert molding step. This offers the advantage that apart from a positioning and fixation of the electrochemical energy storage unit, a support component for the at least one electrochemical energy storage unit can also be created without an additional work step or material expenditure.

The at least one electrochemical energy storage unit can be provided with at least one connecting element also in the preparation step. This can be used for connecting the electrochemical energy storage unit to another electrochemical energy storage unit. The at least one connecting element can be coupled to the at least one electrochemical energy storage unit. The connecting element can be made, for example, in the form of a rail. The coupling between the connecting element and the electrochemical energy storage unit can be realized, e.g., by gluing or screwing of the connecting element onto the energy storage unit. This offers the advantage that the connecting element can be applied to the still not fixed electrochemical energy storage unit, because this is simpler in comparison with the application of a connector to an energy storage unit already fitted into a frame. Because the casting compound is applied in a later work step in liquid or at least elastic form, the connecting element can be taken up simply in the sheathing.

According to another embodiment of the invention, in the preparation step the at least one electrochemical energy storage unit can be provided with at least one cooling element for cooling the electrochemical energy storage unit. The at least one cooling element can be coupled to the at least one electrochemical energy storage unit. The cooling element can be, e.g., in the form of a cooling plate. The binding of the cooling element to the electrochemical energy storage unit can occur, for example, by pressure or also by adhesion. Here as well, there is the advantage that the cooling element can be applied in a simple way to the still not fixed electrochemical energy storage unit and in the work step of insert molding can be taken up easily in the sheathing by the casting compound.

The present invention creates further an energy storage device, comprising the following features: at least one electrochemical energy storage unit, which is suitable for powering a vehicle, and a casting compound, whereby the electrochemical energy storage unit is enclosed at least partially by the casting compound and is connected form-fittingly and/or by bonding to the casting compound.

According to an embodiment, the at least one electrochemical energy storage unit can have wedge-shaped edges. The wedge-shaped edges can be embedded in the casting compound. This creates the advantage that by means of the selected form of the edges of the electrochemical energy storage unit an improved form-fitting and/or bonded connection between the cured casting compound and the electrochemical energy storage unit can be realized, because the mechanical interlocking of the two elements is strengthened by the wedge-shaped design of the edges of the energy storage unit. A wedge shape at the edges of the energy storage unit provides, in addition, a large surface, to which the casting compound can bind well in a bonding manner.

The energy storage device can also have at least one second electrochemical energy storage unit. The second electrochemical energy storage unit in this case can also be surrounded by the casting compound or embedded in the casting compound. The approach of insert molding with a casting compound offers the advantage that a plurality of electrochemical energy storage units can be provided with an enclosure in one work step. Therefore, no additional work step is necessary for the possible joining of individual frames.

Finally, the casting compound may contain a polyamide. Advantageously, a sheathing, which is cost-effective and easy to process, for one or more electrochemical energy storage units can be realized in this way. In addition, polyamide has a high ability to resist mechanical damage and attacks by chemicals and offers very good adhesion to the surface of the energy storage unit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a flowchart of a method for producing an energy storage device, according to an exemplary embodiment of the invention;

FIG. 2 shows an illustration of an energy storage device in a plan view, according to an exemplary embodiment of the invention; and

FIG. 3 shows a sectional view of the exemplary embodiment of the energy storage device according to the invention from FIG. 2.

### DETAILED DESCRIPTION

In the following description of the preferred exemplary embodiments of the present invention, the same or similar reference characters are used for the elements with a similar action and shown in the different drawings, whereby a repeated description of these elements is omitted. If an exemplary embodiment includes an “and/or” conjunction between a first feature and a second feature, then this can be read such that the exemplary embodiment according to one embodiment has both the first feature and the second feature and according to another embodiment either only the first feature or only the second feature.

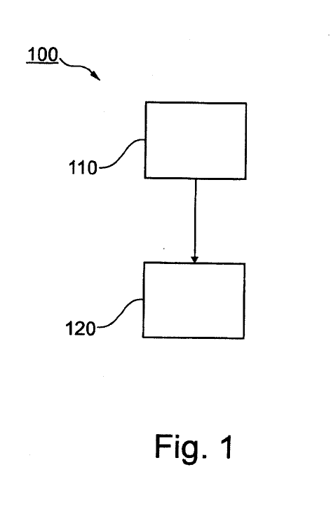

FIG. 1 shows a method 100 for producing an energy storage device for at least one electrochemical energy storage unit, according to an exemplary embodiment of the invention.

Method 100 comprises a preparation step 110 of the at least one electrochemical energy storage unit. Further, method 100 comprises a step 120 of the at least partial insert molding of the at least one electrochemical energy storage unit with a casting compound, to produce the energy storage device. As a result of method 100, the at least one electrochemical energy storage unit is connected to the casting compound form-fittingly and/or by bonding.

Alternatively, steps 110 and 120 of method 100 can also be carried out in the reverse order. Thus, for example, first the casting compound can be filled into an injection mold and then the at least one electrochemical energy storage unit can be pressed into the still liquid casting compound.

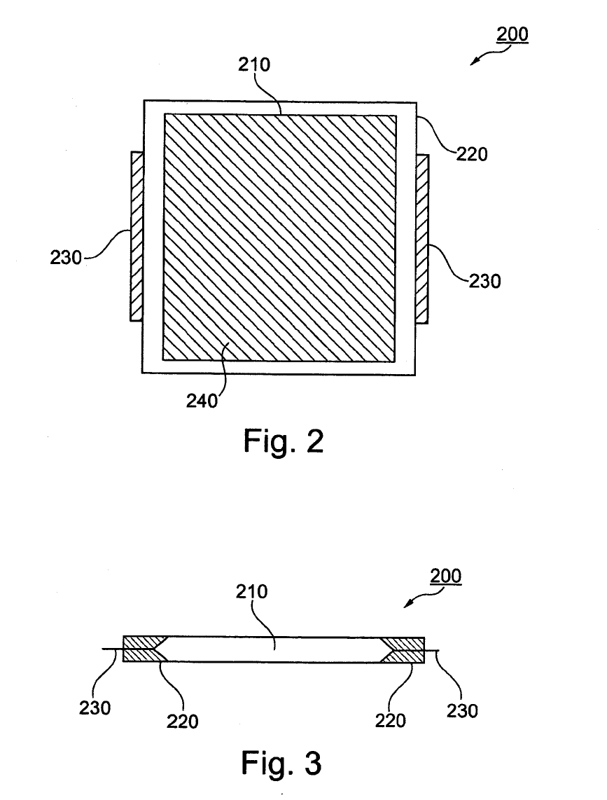

FIG. 2 shows a plan view of an exemplary embodiment of an energy storage device 200 of the invention. Shown are an electrochemical energy storage unit or, more simply stated, cell 210, a casting compound 220, and two arresters provided with the same reference character 230.

In FIG. 2, electrochemical energy storage unit 210 is formed as an almost square flat cell, with one of its two main surfaces 240 facing the viewer. As an alternative to the flat cell, other types of batteries or accumulators can also be used. Flat cell 210 can be formed as a hard case cell or coffee bag cell. As the terms used already suggest, a hard case cell has a rigid housing, whereas a coffee bag cell is sealed in a flexible film. Use of coffee bag cells, which are also known as pouch cells, proves especially advantageous in the automotive sector, because they have a smaller thickness than conventional cells. In the case of the relatively high number of electrochemical energy storage units 210, needed for powering an electric or hybrid vehicle, a considerable saving of space therefore results from the use of coffee bag cells. Furthermore, coffee bag cells are advantageous in terms of production and offer a great variety of designs.

In the exemplary embodiment of energy storage device 200, as shown in FIG. 2, the entire edge region of electrochemical energy storage unit 210 is surrounded by casting compound 220. It is also possible, however, that only parts of energy storage unit 210, for example, the corners of energy storage unit 210, are surrounded by casting compound 220. Likewise, it would also be possible to sheath electrochemical energy storage units 210 in their entirety with casting compound 220. From the viewer's point of view, two arresters 230 emerge from the left and right side of energy storage device 200. Arresters 230 can be used for contacting of energy storage unit 210 to an electrical connection or to a thermal heat dissipation unit. Use of one or more than two arresters is also conceivable. Arresters 230 are not completely covered by casting compound 220, so that they can be connected readily, for example, simply to a heat sink.

Finally, FIG. 3 shows a cross section through the exemplary embodiment of energy storage device 200 of FIG. 2. Shown are cell 210, casting compound 220, and left arrester 230 and right arrester 230.

It is evident from FIG. 3 that the edges of electrochemical energy storage unit 210 end in a wedge shape. It can be clearly seen that an intensive form-fitting connection between casting compound 220 and energy storage unit 210 is realized by such formed edges of electrochemical energy storage unit 210. The surface of energy storage unit 210 is also much greater than would be the case in a block-shaped energy storage unit. It is therefore possible with the large surface that a very good and strong adhesion of the casting compound to the surface of energy storage unit 210 can be formed.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing an energy storage device for at least one electrochemical energy storage unit, the method comprising:
preparing the at least one electrochemical energy storage unit, which is configured for providing energy for a drive mechanism of a vehicle; and
at least partial insert molding of the at least one electrochemical energy storage unit with a casting compound to produce the energy storage device,
wherein, in the insert molding step, the at least one electrochemical energy storage unit is connected form-fittingly and/or by bonding to the casting compound.

2. The method according to claim 1, wherein a mechanical support for the at least one electrochemical energy storage unit is formed in the insert molding step.

3. The method according to claim 1, wherein, in the preparation step, the at least one electrochemical energy storage unit is provided with at least one connecting element for connecting the electrochemical energy storage unit to another electrochemical energy storage unit, and wherein the at least one connecting element is coupled to the at least one electrochemical energy storage unit.

4. The method according to claim 1, wherein, in the preparation step, the at least one electrochemical energy storage unit is provided with at least one cooling element for cooling the electrochemical energy storage unit, and wherein the at least one cooling element is coupled to the at least one electrochemical energy storage unit.

5. An energy storage device comprising:
at least one electrochemical energy storage unit configured to provide energy for a drive mechanism of a vehicle; and
a casting compound;
wherein the electrochemical energy storage unit is surrounded at least partially by the casting compound and is connected form-fittingly and/or by bonding to the casting compound.

6. The energy storage device according to claim 5, wherein the at least one electrochemical energy storage unit has wedge-shaped edges, which are embedded in the casting compound.

7. The energy storage device according to claim 5, wherein the energy storage device has at least one second electrochemical energy storage unit that is surrounded by the casting compound.

8. The energy storage device according to claim 5, wherein the casting compound contains a polyamide.
